(19) United States
(12) Patent Application Publication
(10) Pub. No.: US 2018/0157714 A1
(43) Pub. Date: Jun. 7, 2018

(54) SYSTEM, METHOD AND NON-TRANSITORY COMPUTER READABLE STORAGE MEDIUM FOR MATCHING CROSS-AREA PRODUCTS

(71) Applicant: INSTITUTE FOR INFORMATION INDUSTRY, TAIPEI (TW)

(72) Inventors: Chia-Chi WU, Taipei City (TW); Pei-Yu HSIEH, New Taipei City (TW); Meng-Jung SHIH, Taoyuan City (TW)

(21) Appl. No.: 15/372,377

(22) Filed: Dec. 7, 2016

(30) Foreign Application Priority Data
Dec. 1, 2016 (TW) 105139743

(51) Int. Cl. G06F 17/30; G06Q 30/06; G06F 17/22

(52) U.S. Cl. CPC G06F 17/30522; G06F 17/2211; G06F 17/30312; G06Q 30/0633

(57) ABSTRACT

A method for matching cross-area products includes steps as follows. First and second local product lists are matched through text similarity and graph similarity, and a corresponding relation of the matched first and second products is built. A first difference of topic probability vector of the first and second products and a second difference of topic probability vector of third and fourth products are calculated. If the first difference of topic probability vector is similar to the second difference of topic probability vector, the third and fourth products that are failed to be matched are built a corresponding relation. A cross-area product list of the first and second local product lists is generated. First and second local electronic commerce product lists are added in the first and second local area lists. The first and second local area lists corresponding to the cross-area product list are displayed on a displaying device.

### RELATED APPLICATIONS

This application claims priority to Taiwan Application Serial Number 105139743, filed Dec. 1, 2016, which is herein incorporated by reference.

### BACKGROUND

### Technical Field

The disclosed embodiments relate to product matching technology. More particularly, The disclosed embodiments relate to a system, a method and a non-transitory computer-readable storage medium for matching cross-area products.

### Description of Related Art

Many survey results indicate that the largest difficulty for an enterprise to enter an oversea market is lack of oversea market information. Even though the electronic commerce platforms provides lots of, public and available product data, names of many products in different area may be completely different so that the product data still cannot be used merely through translation, that is, the help to enterprise's market valuation is limited.

### SUMMARY

The present disclosure provides a system, a method and a non-transitory computer-readable storage medium for matching cross-area products.

The method for matching cross-area products is as follows: A first local product list and a second local product list are matched through text similarity and graph similarity, and a corresponding relation of the matched first product and the second product is built. The first local product list includes the first product and a third product, and the second local product list includes the second product and a fourth product. The third product and the fourth product are failed to be matched. A first difference of topic probability vector of the first product and the second product and a second difference of topic probability vector of the third product and the fourth product are calculated. If the first difference of topic probability vector is similar to the second difference of topic probability vector, a corresponding relation of the third product and the fourth product that are failed to be matched is built. A cross-area product list of the first local product list and the second local product list is generated. The cross-area product list includes the first product, the second product, the third product and the fourth product. A first local electronic commerce product list is added to the first local product list and a second local electronic commerce product list is added to the second local product list through text similarity. The first local product list and the second local product list corresponding to the cross-area product list are displayed on a displaying device.

The system for matching cross-area products includes a database and a processor. The processor is coupled to the database. The database is configured to store a first local product list and a second local product list. The first local product list includes a first product and a third product, and the second local product list includes a second product and a fourth product. The processor is configured to match the first local product list and the second local product list through text similarity and graph similarity, and build a corresponding relation of the matched first product and the second product. The third product and the fourth product are failed to be matched. The processor is further configured to calculate a first difference of topic probability vector of the first product and the second product and a second difference of topic probability vector of the third product and the fourth product, and build a corresponding relation of the third product and the fourth product that are failed to be matched if the first difference of topic probability vector is similar to the second difference of topic probability vector. The processor is further configured to generate a cross-area product list of the first local product list and the second local product list, add a first local electronic commerce product list to the first local product list and add a second local electronic commerce product list to the second local product list through text similarity, and display the first local product list and the second local product list corresponding to the cross-area product list on a displaying device. The cross-area product list includes the first product, the second product, the third product and the fourth product.

The non-transitory computer-readable storage medium storing program instructions for causing a processor to perform a method for matching cross-area products, and the method for matching cross-area products is as follows: A first local product list and a second local product list are matched through text similarity and graph similarity, and a corresponding relation of the matched first product and the second product is built. The first local product list includes the first product and a third product, and the second local product list includes the second product and a fourth product. The third product and the fourth product are failed to be matched. A first difference of topic probability vector of the first product and the second product and a second difference of topic probability vector of the third product and the fourth product are calculated. If the first difference of topic probability vector is similar to the second difference of topic probability vector, a corresponding relation of the third product and the fourth product that are failed to be matched is built. A cross-area product list of the first local product list and the second local product list is generated. The cross-area product list includes the first product, the second product, the third product and the fourth product. A first local electronic commerce product list is added to the first local product list and a second local electronic commerce product list is added to the second local product list through text similarity. The first local product list and the second local product list corresponding to the cross-area product list are displayed on a displaying device.

In conclusion, the present disclosure can match the same product with product names that are not completely the same in the different areas to generate a cross-area product list through text similarity, graph similarity and the differences of topic probability vector. Moreover, the present disclosure can also integrate the items with complicated names (including volume, quantity, product mix information) on the electronic commerce platforms in the local product lists so as to further correspond to the cross-area product list. Therefore, the user can know specific product information (e.g., price, sales quantity) in the different area for business valuation according to the cross-area product list.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a system for matching cross-area products according to an embodiment of the present disclosure;

FIG. 2 is a flow chart of a method for matching cross-area products according to an embodiment of the present disclosure;

FIG. 3 is a schematic diagram of a situation of application according to an embodiment of the present disclosure;

FIG. 4 is a sub-flow chart of the flow chart shown in FIG. 2;

FIG. 5 is a sub-flow chart of the flow chart shown in FIG. 2;

FIG. 6 is a sub-flow chart of the sub-flow chart shown in FIG. 5; and

FIG. 7 is a schematic diagram of differences of topic probability vector according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled,” and the term “connected” may be termed as “electrically connected.” “Coupled” and “connected” may also be used to indicate that two or more elements cooperate or interact with each other.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

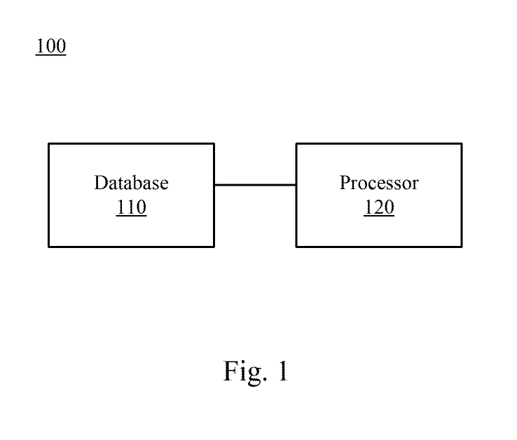

Reference is made to FIGS. 1, 2 and 3. FIG. 1 is a schematic diagram of a system 100 for matching cross-area products according to an embodiment of the present disclosure. The system 100 includes a database 110 and a processor 120. The database 110 is coupled to the processor 120 and configured to store a first local product list 312 and a second local product list 322. The first local product list 312 includes a first product and a third product, and a second local product list 322 includes a second product and a fourth product.

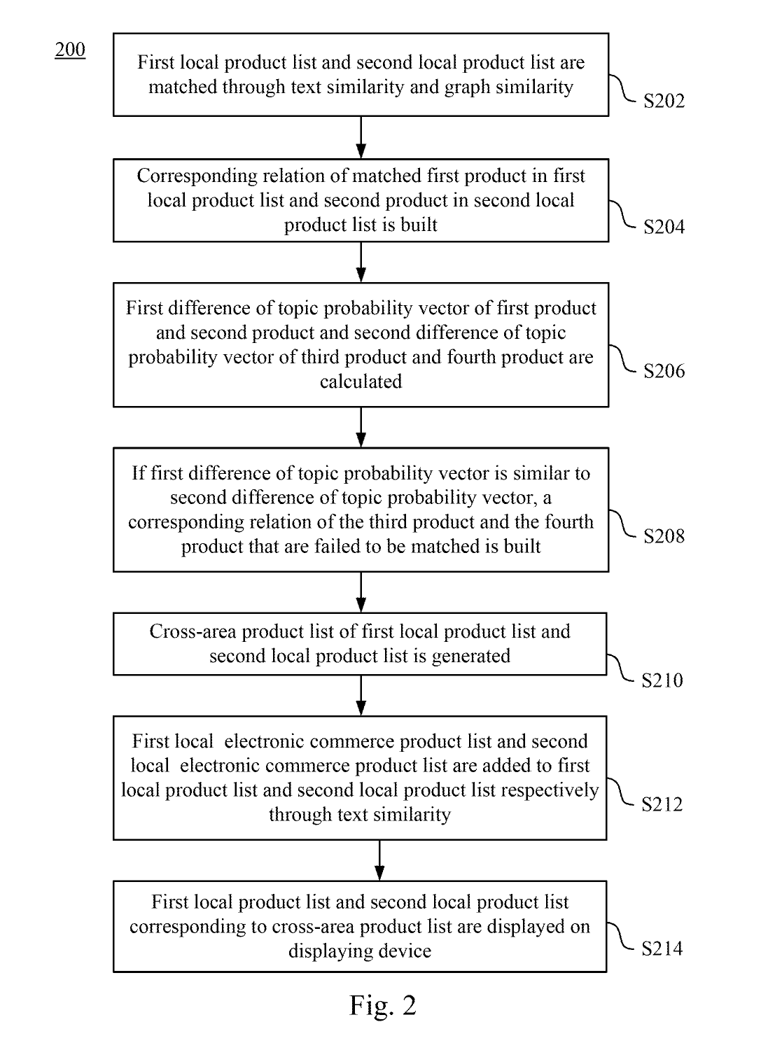

FIG. 2 is a flow chart of a method 200 for matching cross-area products according to an embodiment of the present disclosure. The method 200 includes steps S202-S214, and the method 200 can be applied to the system 100 as shown in FIG. 1. The method 200 can be implemented as computer programs stored in a non-transitory computer-readable medium, which is loaded by a processor to make the processor execute the method 200. The non-transitory computer-readable medium can be read only memory (ROM), flash memory, soft disk, hard disk, optical disk, pen drive, magnetic tape, network accessible database, or other computer-readable medium with the same function that are obvious for those skilled in the art. However, those skilled in the art should understand that the mentioned steps in the present embodiment are in an adjustable execution sequence according to the actual demands except for the steps in a specially described sequence, and even the steps or parts of the steps can be executed simultaneously.

In order to generate a cross-area product list 332 of an area 310 (e.g., country A) and an area 320 (e.g., country B), the processor 120 may collect local product lists 312, 322 from reference websites 311, 321 (e.g., product review websites) of different areas 310, 320, and delete repeated products in the local product lists 312, 322. It should be noted that the local product lists 312, 322 may include product category, brand name, product name and product graph, and the number of the areas 310, 320 is merely an example. However, the present disclosure is not limited thereto.

In step S202, the processor 120 matches the first local product list 312 and the second local product list 322 through text similarity and graph similarity. If the matching is successful, the processor 120 build a corresponding relation of the matched first product in the first local product list 312 and the second product in the second local product list 322 in step S204. It should be noted that the processor determines that the third product in the first local product list 312 and the fourth product in the second local product list 322 are failed to be matched through text similarity and graph similarity.

In order to further match the third product and the fourth product, the processor 120 calculates a first difference of topic probability vector of the first product and the second product and a second difference of topic probability vector of the third product and the fourth product in step S206. If the first difference of topic probability vector is similar to the second difference of topic probability vector, the processor 120 builds a corresponding relation of the third product and the fourth product that are failed to be matched in step S208. As a result, the processor 120 can generate the cross-area product list 332 of the first local product list 312 and the second local product list 322 in step S210. The cross-area product list 332 includes the first product, the second product, the third product and the fourth product that are built the corresponding relations.

In order to integrate electronic commerce products (e.g., products on auction websites) with the first local product list 312 and the second local product list 322, the processor 120 may collect local electronic commerce product lists 314, 324 from electronic commerce platforms 313, 323 (e.g., auction websites) of the areas 310, 320, and add the first local electronic commerce product list 314 to the first local product list 312, and add the second local electronic commerce product list 324 to the second local product list 322 through text similarity in step S212. Then, the processor 120 displays the first local product list 312 and the second local product list 322 corresponding to cross-area product list 332 on a displaying device (e.g., a display) in step S214.

As a result, the present disclosure can match the same product with different name in the different areas 310, 320 to generate the cross-area product list 332 through text similarity, graph similarity and the differences of topic probability vector. Moreover, the present disclosure can also integrate items with complicated names on the electronic commerce platforms with the local product lists 312, 322 to further be corresponding to the cross-area product list 332 through text similarity. Therefore, a user can know specific product information (e.g., price, sales quantity) in the different areas 310, 320 according to the cross-area product list 332 for business valuation.

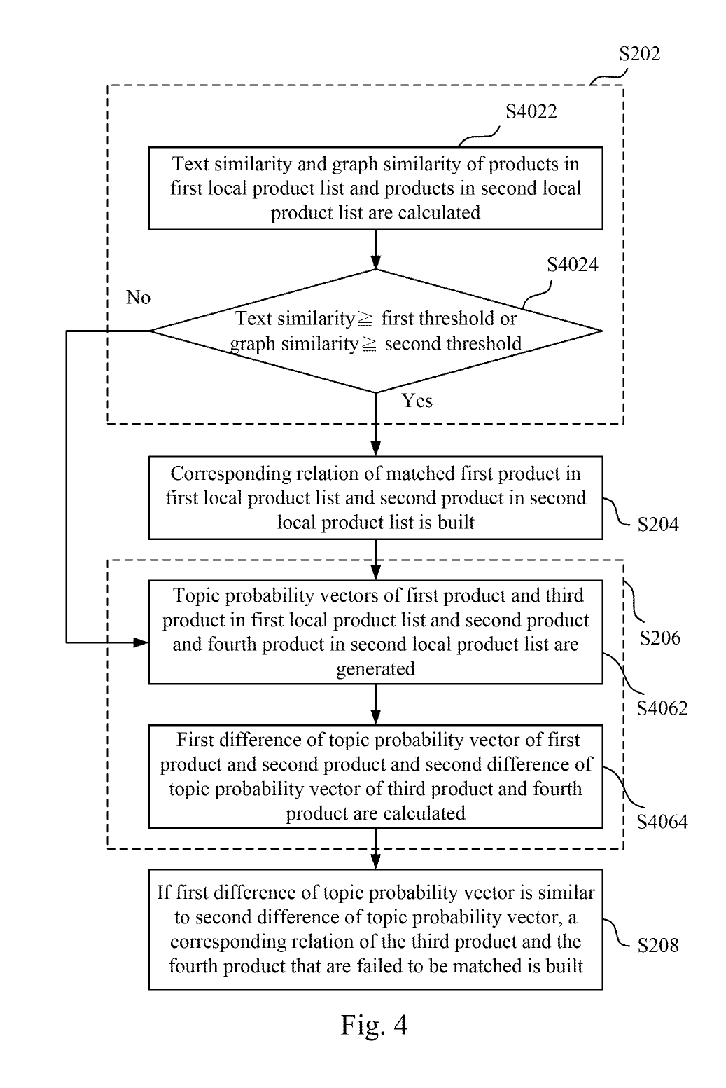

Regarding to a specific embodiment of steps S202-S208, reference is made to FIG. 4. First, the processor 120 can assign an area i (e.g., the area 310) as a target area, and use a local product list (e.g., the local product list 312) of the area i as initial contents of the cross-area product list 332. In step S4022, the processor 120 calculates a text similarity TextSim and a graph similarity GraphSim of products in the first local product list 312 of the area 310 and products in the second local product list 322 of the area 320.

Regrading to method for calculating text similarity, specifically, because product names and brand names are mostly expressed in local language or English in different areas, for example, a x-th product in the local product list 312 of the area i (e.g., the area 310) has a brand name EB(i, x) in English, a brand name LB(i, x) in local language, a product name EP(i, x) in English and a product name LP(i, x) in local language. A y-th product in the local product list 322 of another area d (e.g., the area 320) has a brand name EB(d, y) in English, a brand name LB(d, y) in local language, a product name EP(d, y) in English and a product name LP(d, y) in local language.

The text similarity may be calculated by using string matching technology (e.g., Jaccard index, edit distance, cosine similarity), and the calculated value is normalized to a range between 0 to 1. For example of longest common subsequence (LCS) of edit distance, LCS(“ABCCD”, “EBCD”) is 3, LCS(“ABCCD”, “CDEB”) is 5, a string similarity StringSim(“ABCCD”, “EBCD”) is 6/9, and a string similarity StringSim(“ABCCD”, “CDEB”) is 4/9. Therefore, the processor 120 can calculate a brand name similarity BrandSim(product(i, x), product(d, y)) and a product name similarity ProductSim(product(i, x), product(d, y)) of the x-th product product(i, x) in the area i (e.g., the area 310) and the y-th product product(d, y) in the area d (e.g., the area 320) according to Eqs. (1), (2), and further calculate a text similarity TextSim(product(i, x), product(d, y)) according to Eq. (3). The y-th product may be the first product to the last product in the local product list 322 of the area 320 in order to calculate the text similarity TextSim(product(i, x), product(d, y)) of the x-th product product(i, x) in the area 310 and every product product(d, y) in the area 320.

BrandSim(product(i, x), product(d, y))=max(StringSim(EB(i, x), EB(d, y)), StringSim(EB(i, x), LB(d, y)), StringSim(LB(i, x), EB(d, y)), StringSim(LB(i, x), LB(d, y))) Eq. (1)

ProductSim(product(i, x), product(d, y))=max(StringSim(EP(i, x), EP(d, y)), StringSim(EP(i, x), LP(d, y)), StringSim(LP(i, x), EP(d, y)), StringSim(LP(i, x), LP(d, y))) Eq. (2)

TextSim(product(i, x), product(d, y))=BrandSim(product(i, x), product(d, y))+ProductSim(product(i, x), product(d, y)) Eq. (3)

It should be noted that the processor 120 select a maximum of the string similarities StringSim(EB(i, x), EB(d, y)), StringSim(EB(i, x), LB(d, y)), StringSim(LB(i, x), EB(d, y)) and StringSim(LB(i, x), LB(d, y)) according to Eq. (1), that is, the maximum is the brand name similarity BrandSim(product(i, x), product(d, y)). Similarly, the processor 120 selects a maximum of string similarities StringSim(EP(i, x), EP(d, y)), StringSim(EP(i, x), LP(d, y)), StringSim(LP(i, x), EP(d, y)) and StringSim(LP(i, x), LP(d, y)) according to Eq. (2), that is, the maximum is the product name similarity ProductSim(product(i, x), product(d, y)). Then, the processor 120 adds the brand name similarity BrandSim(product(i, x), product(d, y)) and the product name similarity ProductSim(product(i, x), product(d, y)) to calculate the text similarity TextSim(product(i, x), product(d, y)).

Regarding to method of calculating graph similarity, specifically, the processor 120 can search graph of the x-th product in the area i (e.g., the area 310) through a search engine (e.g., Google), and acquire the first n webpage IRR(i, x). It should be noted that the webpage IRR(i, x) is defined as {irr1(i, x), irr2(i, x), . . . , irrn(i, x)}, in which the irrn(i, x) is the n-th webpage and n is a positive integer. Similarly, the processor 120 can search graph of the y-th product in the area d (e.g., the area 320) through the search engine, and acquire the first n webpage IRR(d, y). Therefore, the processor 120 can calculate a graph similarity GraphSim(product(i, x), product(d, y)) of the x-th product in the local product list 312 of the area i (e.g., the area 310) and the y-th product in the local product list 322 of the area d (e.g., the area 320) according to Eq. (4) or Eq. (5).

$$\begin{matrix}GraphSim ( product ( i , x ) , product ( d , y ) ) = \frac{\vert IRR ( i , x ) ⋂ IRR ( d , y ) \vert}{n} & Eq . ( 4 ) \\ GraphSim ( product ( i , x ) , product ( d , y ) ) = \frac{{\sum }_{s = 2}^{n} {\sum }_{t = 1}^{s - 1} ( content similarity of irrs ( i , x ) and irrt ( d , y ) )}{\frac{n \times ( n - 1 )}{2}} & Eq . ( 5 )\end{matrix}$$

It should be noted that irrs(i, x) and irrt(d, y) is the s-th webpage and the t-th webpage in IRR(i, x) and IRR(d, y) respectively, a content similarity of the webpages irrs(i, x) and irrt(d, y) may be calculated by known article matching method. For example, the processor 120 calculates a ratio of common words after executing word segmentation on the webpages irrs(i, x) and irrt(d, y). Alternatively, the processor 120 can also calculate a weighted similarity after calculating a term frequency-inverse document frequency (TF-IDF) of the webpages irrs(i, x) and irrt(d, y).

Through the aforementioned methods, the processor 120 can calculate the text similarity TextSim and the graph similarity GraphSim of the products in the first local product list 312 and the products in the second local product list 322 in step S4022. In step S4024, the processor 120 determines whether the text similarity TextSim is larger than a first threshold and whether the graph similarity GraphSim is larger than a second threshold. It should be noted that the first threshold and the second threshold may be determined by an expert or determined through a known statistical analysis method or a machine-learning method.

For example, the processor 120 calculates a first text similarity TextSim1 and a first graph similarity GraphSim1 of the first product in the first local product list 312 and the second product in the second local product list 322. If the first text similarity TextSim1 is larger than or equal to the first threshold, or the first graph similarity GraphSim1 is larger than or equal to the second threshold, the processor 120 determines that the first product and second product are matched in step S4024, and builds the corresponding relation of the matched first product in the first local product list 312 and the second product in the second local product list 322 in step S204.

In contrast, the processor 120 calculates a second text similarity TextSim2 and a second graph similarity GraphSim2 of the third product in the first local product list 312 and the fourth product in the second local product list 322. If the second text similarity TextSim2 is smaller than the first threshold and the second graph similarity GraphSim2 is smaller than the second threshold, the processor 120 determines that the third product and the fourth product are failed to be matched in step S4024.

Regarding to the third product in the first local product list 312 and the fourth product in the second local product list 322 that are failed to be matched through text similarity and graph similarity by the processor 120, the processor 120 further uses a difference of topic probability vector for matching. In step S4062, the processor 120 generates topic probability vectors of the first product and the third product in the first local product list 312 and the second product and the fourth product in the second local product list 322. It should be noted that processor 120 may use probabilistic topic model, principal components analysis (PCA), tensor analysis to generate the topic probability vectors.

For example of latent Dirichlet allocation (LDA) of probabilistic topic model, the processor may collect at least n (e.g., 50) product description or comments regarding to the x-th product product(i, x) in the area i (e.g., the area 310), and connect the product description or the comments to generate a document document(i, x). Likely, the processor 120 generates a document document(d, y) regarding to the y-th product product(d, y) in the area d (e.g., the area 320). Then, the processor 120 converts languages of the documents of all products in all the areas to the same language (e.g., English) through a translation tool (e.g., Google translate), and generates a word document matrix accordingly.

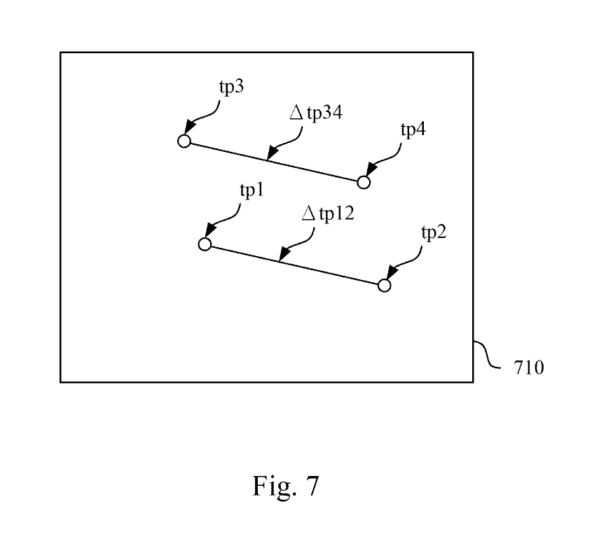

The processor 120 uses LDA method to decompose the word document matrix into a word topic matrix and a topic document matrix. It should be noted that elements p(tl, document(i,x)) in the topic document matrix indicates that a probability that a topic tl exists in a document document(i,x), and a topic probability vector tp_product(i, x) is defined as (p(t1, document(i,x)), p(t2, document(i,x)), . . . , p(tn, document(i,x)), . . . ). Therefore, the processor 120 can generate a topic probability vector tp1 of the first product and a topic probability vector tp3 of the third product in the first local product list 312, and a topic probability vector tp2 of the second product and a topic probability vector tp4 of the fourth product in the second local product list 322 in step S4062, and calculate a first difference Δtp12 of topic probability vector of the first product and the second product and a second difference Δtp34 of topic probability vector of the third product and the fourth product in step S4064. The topic probability vectors tp1-tp4 and the differences Δtp12, Δtp34 of topic probability vector in a vector space 710 are shown in FIG. 7.

In step S208, if the first difference Δtp12 of topic probability vector is similar to the second difference Δtp34 of topic probability vector, the processor 120 builds the corresponding relation of the third product and the fourth product that are failed to be matched in step S4024. Specifically, the processor 120 uses differences of topic probability vector (e.g., Δtp12) of all the matched products (e.g., first product second product) in step S4024 and the topic probability vector tp3 of the third product to calculate the most similar topic probability vector of a product in the area 320 (e.g., through cosine similarity and setting a threshold). In the present embodiment, the processor 120 determines that the product with the most similar topic probability vector is the fourth product in second local product list 322 of the area 320, and therefore builds the corresponding relation of the third product and the fourth product.

As a result, the present disclosure can use the differences of topic probability vector to further build the corresponding relation of the products (i.e., the third product, the fourth product) in the different local product lists 312, 322 that are failed to be matched through text similarity and graph similarity so as to generate the cross-area product list 332.

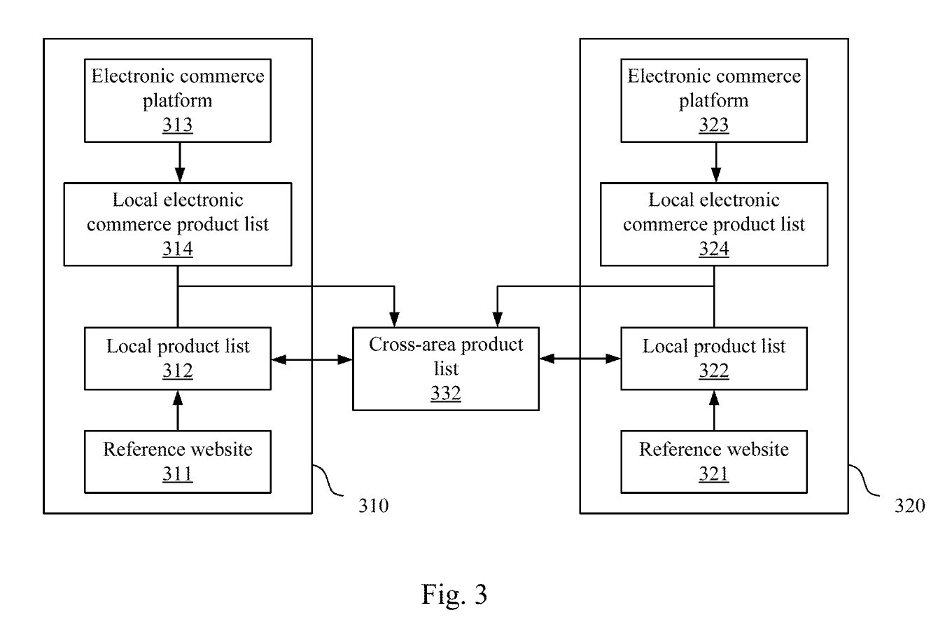

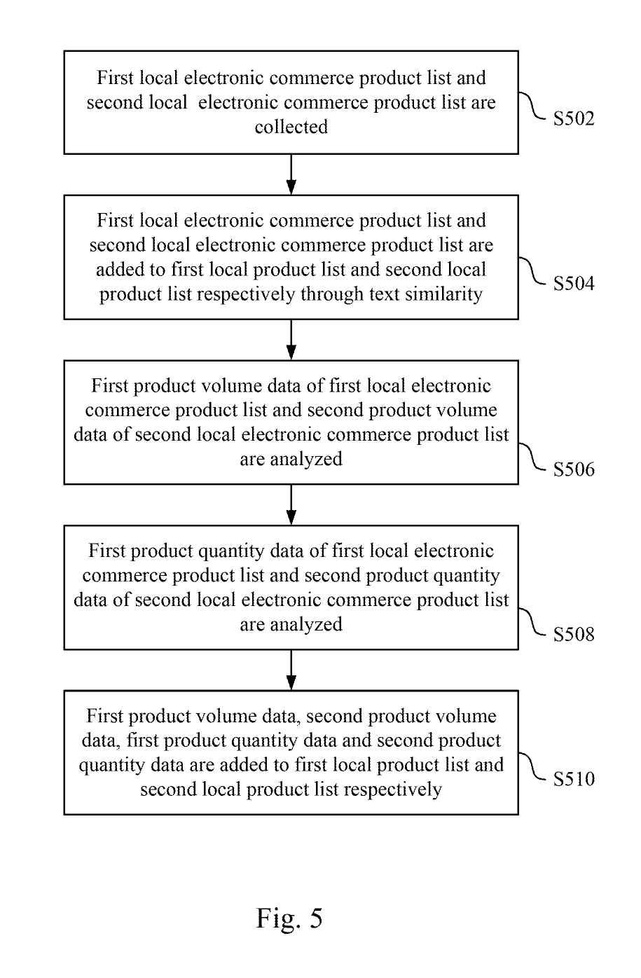

In order to further describe step S212, reference is made to FIGS. 3 and 5. In step S502, the processor 120 collects a first local electronic commerce product list 314 and a second local electronic commerce product list 324. Specifically, the processor 120 may collect the local electronic commerce product lists 314, 324 from electronic commerce platforms 313, 323 (e.g., auction websites) in different areas 310, 320.

In step S504, the processor 120 adds the first local electronic commerce product list 314 to the first local product list 312, and adds the second local electronic commerce product list 324 to the second local product list 322 through text similarity. Specifically, the processor 120 calculate a brand name similarity BrandSim(offers(i, x), product(i, y)) and a product name similarity ProductSim(offers(i, x), product(i, y)) of the x-th item offers(i, x) in the local electronic commerce product list (e.g., local electronic commerce product list 314) of the area i (e.g., the area 310) and every product product(i, y) in the local product list (e.g., the local product list 312) in the same area (e.g., the area 310). It should be noted that because titles of items offers(i, x) in the local electronic commerce product lists 314, 324 may include product brand, product name, volume, seller information and other description. For example of a brand name similarity EBSim(offers(i, x), product(i, y)) in English, the processor 120 may set a word length n of a brand name in English to respectively calculate string similarities of different word intervals of the titles of the items offers(i, x), and select a maximum of the string similarities as the brand name similarity EBSim(offers(i, x), product(i, y)) in English.

Similarly, the processor 120 can calculate a brand name similarity LBSim(offers(i, x), product(i, y)) in local language, a product name similarity EPSim(offers(i, x), product(i, y)) in English and a product name similarity LPSim(offers(i, x), product(i, y)) in local language of the item offers(i, x) in the local electronic commerce product list 314 and every product product(i, y) in the local product list 312. Then, the processor calculates a text similarity TextSim(offers(i, x), product(i, y)) of the item offers(i, x) in the local electronic commerce product list 314 and every product product(i, y) in the local product list 312 of the area 310 through Eq. (6).

TextSim(offers(i, x), product(i, y))=max(EBSim(offers(i, x), product(i, y)), LBSim(offers(i, x), product(i, y)))+max(EPSim(offers(i, x), product(i, y)), LPSim(offers(i, x), product(i, y))) Eq. (6)

It should be noted that the processor 120 adds a maximum of the brand name similarity LBSim(offers(i, x), product(i, y)) in English and the brand name similarity LBSim(offers(i, x), product(i, y)) in local language and a maximum of the product name similarity EPSim(offers(i, x), product(i, y)) in English and the product name similarity LPSim(offers(i, x), product(i, y)) in local language to calculate the text similarity TextSim(offers(i, x), product(i, y)) according to Eq. (6).

As aforementioned, the processor 120 can determine whether the text similarity TextSim(offers(i, x), product(i, y)) is larger than or equal to a threshold. The threshold may be determined by an expert or determined through a known statistical analysis method or a machine-learning method. It should be noted that it indicates that there is no products corresponding to the item offers(i, x) in the local product list of the same area if the TextSim(offers(i, x), product(i, y)) is smaller than the threshold. In contrast, if the TextSim(offers(i, x), product(i, y)) is larger than or equal to the threshold, the processor 120 adds the item offers(i, x) corresponding to the product product(i, y) in the local product list 312, replaces a word interval in a title of the item offers(i, x) corresponding to the product name by spaces, and repeats the above process until the calculated TextSim(offers(i, x), product(i, y)) is smaller than the threshold.

As a result, the present disclosure can integrate the complicated local electronic commerce product lists 314, 324 and the local product lists 312, 322 in the same area.

Regarding to the item offers(i, x) in the local electronic commerce product list 314 corresponding to the product product(i, y) in the local product list 312, in one embodiment, the processor 120 can analyze first product volume data of the first local electronic commerce product list 314 and second product volume data of the second local electronic commerce product list 324 in step S506.

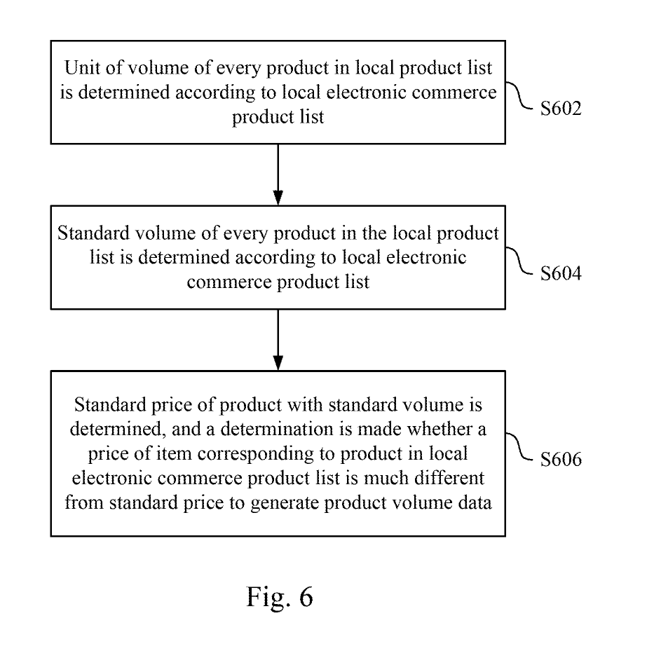

In order to describe step S506, reference is made to FIG. 6. In step S602, the processor 120 determines a unit (e.g., g, ml)) of volume of every product in the local product list 312 (or 322) according to the local electronic commerce product list 314 (or 324). Specifically, the processor 120 determines that the most common unit of volume of all items offers(i, x) corresponding to the product product(i, y) is a unit of volume of the product(i, y). In step S604, the processor 120 determines a standard volume of every product in the local product list 312 (or 322) according to the local electronic commerce product list 314 (or 324). Specifically, the processor 120 determines the most common volume of all the items offers(i, x) corresponding to the product product(i, y) is the standard volume. For example, the processor 120 determines whether appearance frequencies of all the items offers(i, x) corresponding to the product product(i, y) are larger than a threshold (e.g., 10%, which can be determined by an expert or determined through a known statistical analysis method or a machine-learning method).

In step S606, the processor 120 can determine a standard price (e.g., a median of all price of all the products in the standard volume, however, the present disclosure is not limited thereto) of a product product(i, y) with the standard volume, and determine whether a price of the item corresponding to the product product(i, y) in the local electronic commerce product list 314 (or 324) is much different from the standard price to generate product volume data. Because the items on the electronic commerce platforms may have price fluctuation, the processor 120 can set a reasonable range of price fluctuation (e.g., from 50% standard price to 150% standard price, however, the present disclosure is not limited thereto) to determine whether prices of the items in the local electronic commerce product list corresponding to the product product(i, y) are in the reasonable range of price fluctuation, check and mark an item with abnormal price in the local electronic commerce product list 314 (or 324), and then generate first product volume data (or second product volume data).

Items cannot be determined standard volumes by the processor 120 in step S506 may be in a situation where the quantity is more than one or a product mix. Regarding to the items that are not determined the standard volumes, the processor 120 can analyze a first product quantity data of the first local electronic commerce product list 314 and a second product quantity data of the second local electronic commerce product list 324 in step S508. Specifically, the processor 120 first extracts a numeral (e.g., a positive integer n) in a title of the item that is not determined the standard volume, and calculates a plural products' standard price and a reasonable range of price fluctuation (e.g., from (50%*n* standard price) to (150%*n* standard price), however, the present disclosure is not limited thereto) according to the extracted numeral. The processor 120 further determines whether the prices of the items that are not determined the standard volumes is in the plural products' reasonable range of price fluctuation, and generates first product quantity data (or second product quantity data) according to the items in the plural products' reasonable range of price fluctuation.

It should be noted that the processor 120 can also analyze items with product mix in step S508. Specifically, the processor 120 can take a volume word that is the nearest to the product name of the item in the local electronic commerce product list 314 (or 324) as a volume of the product. Therefore, the processor can calculate a reasonable range of price fluctuation of the item with product mix, and generates the first product quantity data (or the second product quantity data) according to the items with product mix in the reasonable range of price fluctuation.

In step S510, the processor 120 adds the first product volume data and the first product quantity data to the first local product list, and adds the second product volume data and the second product quantity data to the second local product list.

The database 110 can be stored in a storage device, such as a hard disk, any non-transitory computer readable storage medium, or a database accessible from network. Those of ordinary skill in the art can think of the appropriate implementation of the database 110 without departing from the spirit and scope of the present disclosure. The processor 120 may be a central processing unit (CPU) or a microprocessor.

In conclusion, the present disclosure can match the same product with product names that are not completely the same in the different areas 310, 320 to generate a cross-area product list 332 through text similarity, graph similarity and the differences of topic probability vector. Moreover, the present disclosure can also integrate the items with complicated names (including volume, quantity, product mix information) on the electronic commerce platforms in the local product lists 312, 322 so as to further correspond to the cross-area product list 332. Therefore, the user can know specific product information (e.g., price, sales quantity) in the different areas 310, 320 for business valuation according to the cross-area product list 332.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for matching cross-area products, comprising:
matching a first local product list and a second local product list through text similarity and graph similarity, and building a corresponding relation of the matched first product and the second product, wherein the first local product list comprises the first product and a third product, the second local product list comprises the second product and a fourth product, and the third product and the fourth product are failed to be matched;
calculating a first difference of topic probability vector of the first product and the second product and a second difference of topic probability vector of the third product and the fourth product;
if the first difference of topic probability vector is similar to the second difference of topic probability vector, building a corresponding relation of the third product and the fourth product that are failed to be matched;
generating a cross-area product list of the first local product list and the second local product list, wherein the cross-area product list comprises the first product, the second product, the third product and the fourth product;
adding a first local electronic commerce product list to the first local product list and adding a second local electronic commerce product list to the second local product list through text similarity; and
displaying the first local product list and the second local product list corresponding to the cross-area product list on a displaying device.

2. The method for matching cross-area products of claim 1, further comprising:
analyzing a first product volume data of the first local electronic commerce product list;
analyzing a second product volume data of the second local electronic commerce product list; and
adding the first product volume data to the first local product list, and adding the second product volume data to the second local product list.

3. The method for matching cross-area products of claim 2, further comprising:
determining a first product standard volume data and a second product standard volume data according to the first product volume data and the second product volume data; and
detecting whether a product with abnormal price exists in the first local electronic commerce product list and the second local electronic commerce product list according to the first product standard volume data and the second product standard volume data.

4. The method for matching cross-area products of claim 1, further comprising:
analyzing a first product quantity data of the first local electronic commerce product list;
analyzing a second product quantity data of the second local electronic commerce product list; and
adding the first product quantity data to the first local product list, and adding the second product quantity data to the second local product list.

5. The method for matching cross-area products of 1, wherein matching the first local product list and the second local product list through text similarity and graph similarity comprises:
calculating a first text similarity and a first graph similarity of the first product and the second product; and
if the first text similarity is larger than or equal to a first threshold or the first graph similarity is larger than or equal to a second threshold, determining that the first product and the second product are matched.

6. The method for matching cross-area products of claim 5, wherein calculating the first text similarity of the first product and the second product comprises:
calculating a brand name similarity and a product name similarity of the first product and the second product; and
adding the brand name similarity and the product name similarity to generate the first text similarity.

7. The method for matching cross-area products of claim 1, wherein matching the first local product list and the second local product list through text similarity and graph similarity comprises:
calculating a second text similarity and a second graph similarity of the third product and the fourth product; and
if the second text similarity is smaller than a first threshold and the second graph similarity is smaller than a second threshold, determining that the third product and the fourth product are failed to be matched.

8. The method for matching cross-area products of claim 1, further comprising:
calculating the first difference of topic probability vector and the second difference of topic probability vector through Latent Dirichlet allocation (LDA).

9. A system for matching cross-area products, comprising:
a database, configured to store a first local product list and a second local product list, wherein the first local product list comprises a first product and a third product, and the second local product list comprises a second product and a fourth product; and
a processor, coupled to the database and configured to match the first local product list and the second local product list through text similarity and graph similarity, and build a corresponding relation of the matched first product and the second product, wherein the third product and the fourth product are failed to be matched, and the processor is further configured to calculate a first difference of topic probability vector of the first product and the second product and a second difference of topic probability vector of the third product and the fourth product, and build a corresponding relation of the third product and the fourth product that are failed to be matched if the first difference of topic probability vector is similar to the second difference of topic probability vector;
wherein the processor is further configured to generate a cross-area product list of the first local product list and the second local product list, add a first local electronic commerce product list to the first local product list and add a second local electronic commerce product list to the second local product list through text similarity, and display the first local product list and the second local product list corresponding to the cross-area product list on a displaying device;
wherein the cross-area product list comprises the first product, the second product, the third product and the fourth product.

10. The system for matching cross-area products of claim 9, wherein the processor is further configured to analyze a first product volume data of the first local electronic commerce product list, analyze a second product volume data of the second local electronic commerce product list, detect whether a product with abnormal price exists in the first product volume data and the second product volume data, add the first product volume data to the first local product list, and add the second product volume data to the second local product list.

11. The system for matching cross-area products of claim 10, wherein the processor is further configured to determine a first product standard volume data and a second product standard volume data according to the first product volume data and the second product volume data, and detect whether a product with abnormal price exists in the first local electronic commerce product list and the second local electronic commerce product list according to the first product standard volume data and the second product standard volume data.

12. The system for matching cross-area products of claim 9, wherein the processor if further configured to analyze a first product quantity data of the first local electronic commerce product list, analyze a second product quantity data of the second local electronic commerce product list, and add the first product quantity data to the first local product list, and adding the second product quantity data to the second local product list.

13. The system for matching cross-area products of claim 9, wherein the processor is further configured to calculate a first text similarity and a first graph similarity of the first product and the second product, and determine that the first product and the second product are matched if the first text similarity is larger than or equal to a first threshold or the first graph similarity is larger than or equal to a second threshold.

14. The system for matching cross-area products of claim 13, wherein the processor is further configured to calculate a brand name similarity and a product name similarity of the first product and the second product, and add the brand name similarity and the product name similarity to generate the first text similarity.

15. The system for matching cross-area products of claim 9, wherein the processor is further configured to calculate a second text similarity and a second graph similarity of the third product and the fourth product, and determine that the third product and the fourth product are failed to be matched if the second text similarity is smaller than a first threshold and the second graph similarity is smaller than a second threshold.

16. The system for matching cross-area products for claim 9, wherein the processor is further configured to calculate the first difference of topic probability vector and the second difference of topic probability vector through Latent Dirichlet allocation (LDA).

17. A non-transitory computer-readable storage medium storing program instructions for causing a processor to perform a method for matching cross-area products, comprising:
matching a first local product list and a second local product list through text similarity and graph similarity, and building a corresponding relation of the matched first product and the second product, wherein the first local product list comprises the first product and a third product, the second local product list comprises the second product and a fourth product, and the third product and the fourth product are failed to be matched;
calculating a first difference of topic probability vector of the first product and the second product and a second difference of topic probability vector of the third product and the fourth product;
if the first difference of topic probability vector is similar to the second difference of topic probability vector, building a corresponding relation of the third product and the fourth product that are failed to be matched;
generating a cross-area product list of the first local product list and the second local product list, wherein the cross-area product list comprises the first product, the second product, the third product and the fourth product;
adding a first local electronic commerce product list to the first local product list and adding a second local electronic commerce product list to the second local product list through text similarity; and
displaying the first local product list and the second local product list corresponding to the cross-area product list on a displaying device.
